(19) United States
(12) Patent Application Publication
(10) Pub. No.: US 2020/0357271 A1
(43) Pub. Date: Nov. 12, 2020

(54) METHOD AND APPARATUS FOR ACTUATING A PUSH-TO-WALK BUTTON

(71) Applicant: JUAN CARLOS RAMIREZ, COSTA MESA, CA (US)

(72) Inventor: JUAN CARLOS RAMIREZ, COSTA MESA, CA (US)

(21) Appl. No.: 16/942,704

(22) Filed: Jul. 29, 2020

(51) Int. Cl. G08G 1/005; G08G 1/07; F16H 53/02

(52) U.S. Cl. CPC G08G 1/005; F16H 53/025; G08G 1/07

(57) ABSTRACT

A method and apparatus for actuating a push-to-walk button wherein a force is received upon a pedal. The force received upon the pedal is then mechanically conveyed to a first cam and applied to the first cam is substantially tangential manner. In response, the first cam rotates and causes a force to be applied to a second cam in order to cause the second cam to impart a force on the push-to-walk button.

### BACKGROUND

In the past few months, the entire world including the United States has found itself in an epoch battle against an invisible enemy·the coronavirus (a.k.a. “COVID-19”). In an effort to quell the spread of COVID-19, governments around the world have ordered citizens to stay in their homes. This is also true in the United States, where several states have issued “shelter-in-place” orders. The Federal Government in the United States has also advised the population to “avoid social gatherings in groups of more than 10 people”, see “The President's Coronavirus Guidelines for America” published on or about Mar. 16, 2020. These guidelines further discourage discretionary travel, shopping trips, and social visits.

The President's guidelines have now been interpreted to require many small businesses in many various industries to effectively shut down during the course of what is now an ongoing COVID-19 pandemic. It is not unfair to say that America, as well as the rest of the world, is closed for business. This is reflected in massive losses in equity markets around the globe. In response to our country's collapsing financial situation, the Federal Government is attempting to infuse capital into the economy. The Federal Reserve has also slashed interest rates. The Federal Government has crafted massive financial recovery legislation, which will infuse trillions of dollars into the American economy. Despite all of these economic stimulus measures, every business in the United States needs to forge their own recovery plan. Government support, although a factor in recovery, is not likely to be effective unless every business develops a recovery plan specific to their own unique circumstances.

As the global population begins working again, people will again take to the streets and flood back into their offices. Common activities of the past will require new protocols to reduce the spread of the current, or any other infectious disease. There are many apparatus in our urban landscape which require human interaction by way of a pushbutton. For example, automatic teller machines require physical touching in order to enter a transaction request. Many of the apparatus we interact with will require update so that they may be operated in a “contactless” manner.

Even before the pandemic befell our world, many modern devices were already embracing a touchless operational paradigm. For example, many gasoline dispensers have been retrofitted so as to interact with a cellular telephone for payment processing. But, there are many apparatus that are simply difficult to retrofit to support contactless operation.

In the vast majority of our cities and urban clusters, signal lights used to govern the flow of automotive traffic also provide mechanisms for the safe passage of pedestrians across an intersection. We've all come to know that a button must be pushed to indicate a pedestrian is present and the desires to cross the street. As more and more people return to normal, or a quasi-normal existence, there will be reluctance to make contact with a “push-to-walk” button because of the numerous people that previously made contact with the same button. Accordingly, even a push-to-walk button will need to be retrofitted in order to help reduce the spread of coronavirus, or other infectious disease.

Many people will continue working from home. This allows for more leisure time, and more walks around the neighborhood. Also, as carbon emission reduction efforts increase we will see more people take to electric bikes and scooters and they will also need to use a push-to-walk button. No one should contract a pathogen when they cross a street.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for actuating a push-to-walk button;

FIG. 2 is a flow diagram that depicts alternative example methods for receiving a force upon a pedal;

FIG. 3 is a flow diagram that depicts one alternative example method for mechanically conveying a force from the pedal to the first cam;

FIG. 4 is a flow diagram that depicts one alternative example method for importing a force upon a second cam when the first cam is rotated;

FIG. 5 is a flow diagram that depicts one alternative example methods for allowing the second cam to press the push-to-walk button;

FIG. 6 is a flow diagram that depicts yet another alternative example method for allowing the second cam to press the push-to-walk button;

FIG. 7 is a flow diagram that depicts one alternative example method for substantially removing the force applied to the push-to-walk button;

FIG. 8 is a pictorial diagram that illustrates one example embodiment of an expanding cam assembly;

FIG. 9A is a pictorial diagram that illustrates the installation of an expanding cam mechanism relative to a push-to-walk button;

FIG. 9B is a pictorial diagram that illustrates mechanical linkage of the rotating cam with a cord;

FIG. 10 is a pictorial diagram that illustrates use of a cord guide in one alternative example embodiment of an expanding cam assembly;

FIG. 11 is a pictorial diagram that illustrates the use of a tensioner in one alternative example embodiments;

FIG. 12 is a diagram that illustrates the formation of a cord way in conjunction with a cover;

FIG. 13 is a pictorial diagram that illustrates one example embodiment of a pedal assembly;

FIG. 14 is a pictorial diagram that illustrates attachment of a cable to a pedal;

FIG. 15 is a pictorial diagram that illustrates application of a cover to an expanding cam assembly; and

FIG. 16 is a pictorial diagram that illustrates one example embodiment of a push-to-walk button actuation mechanism as it may be installed on a push to walk button assembly.

### DETAILED DESCRIPTION

In the interest of clarity, several example alternative methods are described in plain language. Such plain language descriptions of the various steps included in a particular method allow for easier comprehension and a more fluid description of a claimed method and its application. Accordingly, specific method steps are identified by the term “step” followed by a numeric reference to a flow diagram presented in the figures, e.g. (step 5). All such method “steps” are intended to be included in an open-ended enumeration of steps included in a particular claimed method. For example, the phrase “according to this example method, the item is processed using A” is to be given the meaning of “the present method includes step A, which is used to process the item”. All variations of such natural language descriptions of method steps are to be afforded this same open-ended enumeration of a step included in a particular claimed method.

Unless specifically taught to the contrary, method steps are interchangeable and specific sequences may be varied according to various alternatives contemplated. Accordingly, the claims are to be construed within such structure. Further, unless specifically taught to the contrary, method steps that include the phrase “. . . comprises at least one or more of A, B, and/or C . . . ” means that the method step is to include every combination and permutation of the enumerated elements such as “only A”, “only B”, “only C”, “A and B, but not C”, “B and C, but not A”, “A and C, but not B”, and “A and B and C”. This same claim structure is also intended to be open-ended and any such combination of the enumerated elements together with a non-enumerated element, e.g. “A and D, but not B and not C”, is to fall within the scope of the claim. Given the open-ended intent of this claim language, the addition of a second element, including an additional of an enumerated element such as “2 of A”, is to be included in the scope of such claim. This same intended claim structure is also applicable to apparatus and system claims.

In many cases, description of various alternative example methods is augmented with illustrative use cases. Description of how a method is applied in a particular illustrative use case is intended to clarify how a particular method relates to physical implementations thereof. Such illustrative use cases are not intended to limit the scope of the claims appended hereto.

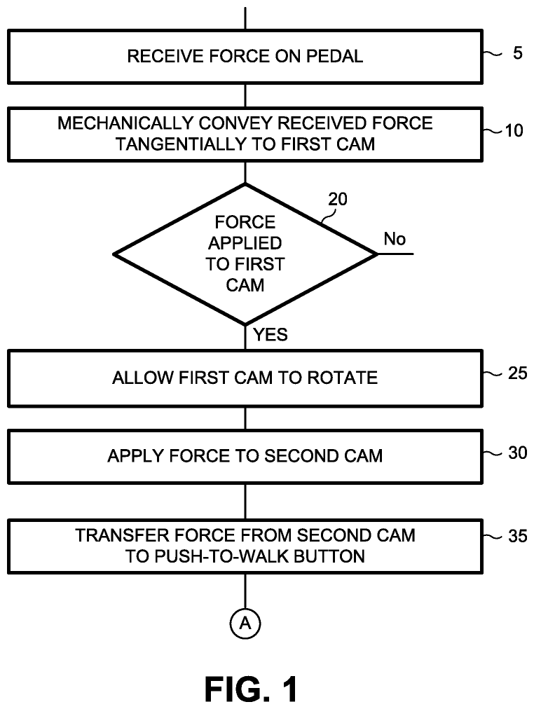

FIG. 1 is a flow diagram that depicts one example method for actuating a push-to-walk button. This example method includes a step for receiving a force upon the pedal (step 5) where the pedal is disposed proximate to a base of a pole that is supporting the push-to-walk button. According to this example method, an additional included step provides for mechanically conveying the force received upon the pedal to a first cam (step 10). It should be appreciated that, according to this example method, the force is conveyed to the first cam in a tangential manner so as to cause the first cam to rotate. Accordingly, an additional included step provides for allowing the first cam to rotate (step 25) when a force is applied to tangentially to the first cam (step 20).

As the first cam is rotated, an additional included step provides for applying a force to a second cam (step 30). In this example method, the force applied to the second cam includes a component that is substantially aligned with an axis of rotation associated with the first cam. It should likewise be appreciated that, according to various illustrative use cases, the second cam is centered substantially about the same axis of rotation as does the first cam. It should likewise be appreciated that the second cam is substantially fixed about the axis of rotation. In other words, the second cam is not allowed to rotate. In this manner, as the force is applied from the first cam to the second cam, the second cam experiences a displacement along the axis of rotation. As the second cam is displaced along the axis of rotation, it transfers the force (step 35) received from the first cam to a push-to-walk button.

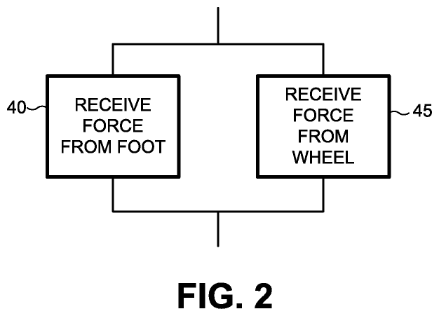

FIG. 2 is a flow diagram that depicts alternative example methods for receiving a force upon a pedal. According to one alternative example method, receiving a force upon a pedal comprises an included step of receiving a force from a foot (step 40). It should likewise be appreciated that, according to one illustrative use case, pedestrians would use their foot to impart a force upon the pedal, where such pedal is situated close to walking level.

According yet another alternative example method, an included step provides for receiving a force from a wheel (step 45). It should be appreciated that, according to yet another illustrative use case, certain people with disabilities may be confined to a wheelchair. Accordingly, such disabled individuals would use the wheel of the wheelchair to actuate the pedal. In order to accommodate such use cases, one example embodiment of the pedal would provide for a slope that rises upward from a leading edge of the pedal. In such an embodiment, the trailing edge of the pedal would be depressed upon application of force by a wheel rolling onto the leading edge of the pedal.

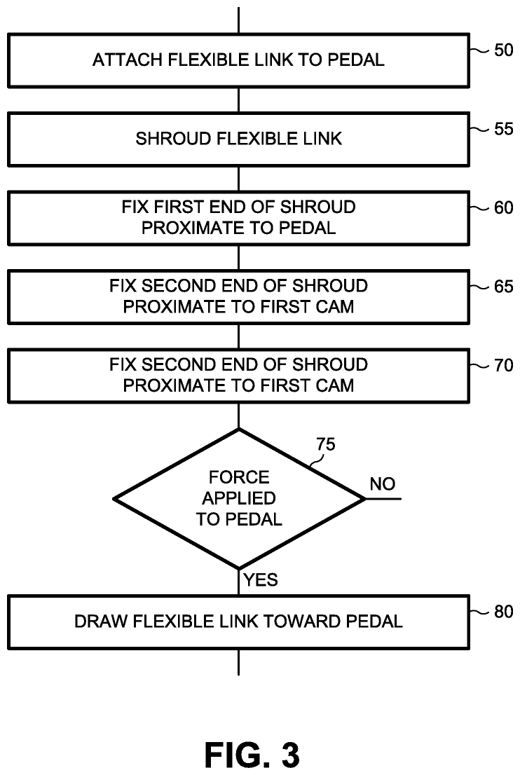

FIG. 3 is a flow diagram that depicts one alternative example method for mechanically conveying a force from the pedal to the first cam. According to this example alternative method, a first included step provides for attaching a flexible link to the pedal (step 15). The flexible link is then envelope in a shroud in an additional included step (step 55). This alternative example method further includes steps for fixing a first end of the shroud proximate to the pedal (step 60) and fixing a second end of the shroud proximate to the first cam (step 65). The flexible link, in this alternative example method, is drawn toward the pedal (step 80) when a force is applied thereto (step 75).

This alternative example method includes an additional step for conveying force from the flexible link to the cam. It should be appreciated that, according to various illustrative use cases, the force conveyed from the flexible link to the cam is not necessarily accomplished by attaching the flexible link directly to the first cam. For example, one alternative example embodiment of an apparatus that applies this alternative example method provides for an intermediate flexible member that is connected to the first cam on one end and to the flexible member on the other.

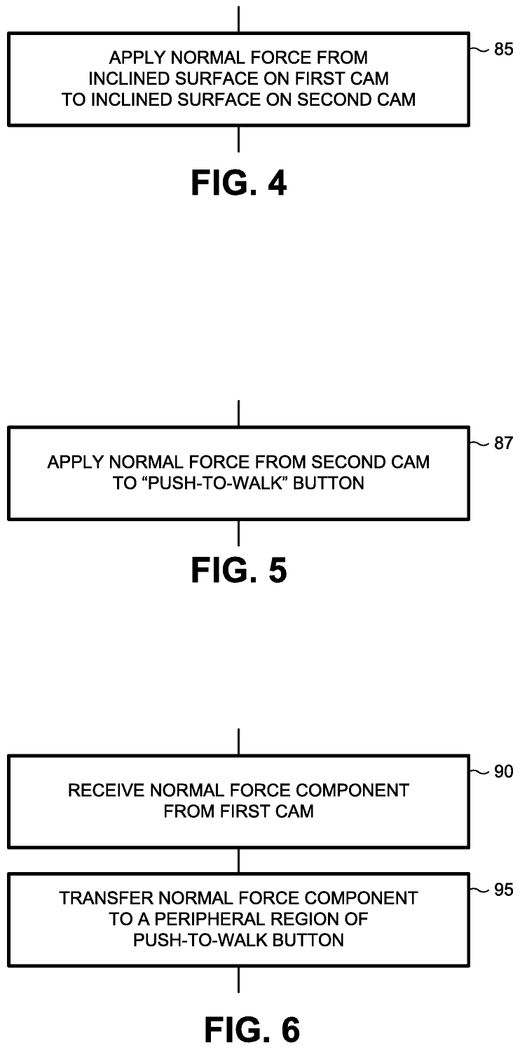

FIG. 4 is a flow diagram that depicts one alternative example method for importing a force upon a second cam when the first cam is rotated. It should be appreciated that, according to various illustrative use cases, the first cam is allowed to rotate about a rotation axis. The second cam is centered substantially about the same rotation axis, but is restrained from rotating. Accordingly, this alternative example method provides for applying a substantially normal force from an inclined surface included on the first cam to an inclined surface included on the second cam (step 85). It should be appreciated that, as the inclined surface on the first cam engages with a corresponding inclined surface on the second cam, rotation of the first cam will cause the second cam to be displaced substantially along the axis of rotation.

FIG. 5 is a flow diagram that depicts one alternative example methods for allowing the second cam to press the push-to-walk button. It should likewise be appreciated that, as the second cam is displaced substantially along the axis of rotation, the force it receives from the first cam is imparted directly upon the push-to-walk button. Accordingly, the normal force received from the first cam is thus conveyed to the push-to-walk button (step 87).

FIG. 6 is a flow diagram that depicts yet another alternative example method for allowing the second cam to press the push-to-walk button. In this alternative example method, the normal force component received from the first cam (step 90) is transferred to a peripheral region of the push-to-walk button (step 95). It should be appreciated that, according to various illustrative use cases, a central region of the push-to-walk button is exposed and the second cam includes a void to allow a user to press the push-to-walk button in a customary manner, e.g. by pressing the button itself with their finger. As such, the push-to-walk button, in one illustrative use case, may be engaged either by pushing the button with a finger or other object or in another case by applying a force to the pedal in accordance with the teachings of the present method and variations thereof.

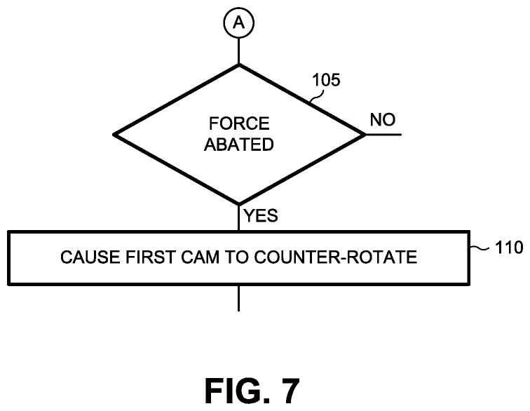

FIG. 7 is a flow diagram that depicts one alternative example method for substantially removing the force applied to the push-to-walk button. It should be appreciated that, according to various illustrative example embodiments, a flexible link attached to a pedal is typically effective only when the pedal causes the flexible link to be drawn toward the pedal and away from the first cam. In other words, the flexible link is only tensely effective. Thus, as addressed by this alternative example method, an additional included step provides for counter-rotating the first cam (step 110) when the force applied to the pedal is abated (step 105).

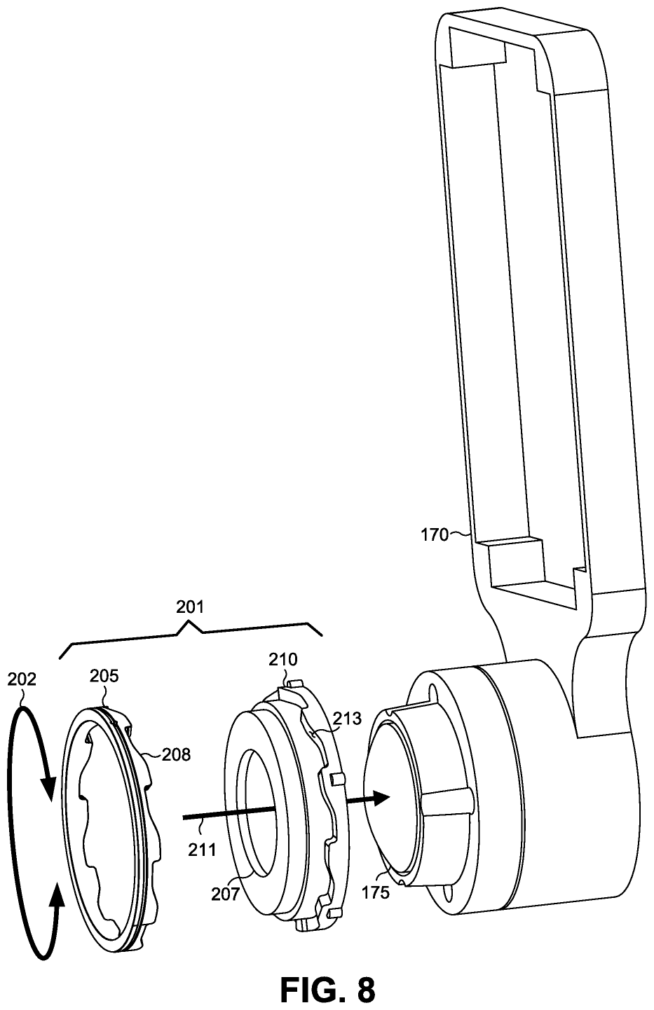

FIG. 8 is a pictorial diagram that illustrates one example embodiment of an expanding cam assembly. According to this example embodiment, an expanding cam assembly 201 comprises a fixed cam 210, and a rotating cam 205. As heretofore described, the fixed cam 210 is substantially centered about an axis of rotation 211. The rotating cam 205 rotates 202 substantially about the same axis of rotation 211. It should also be noted that the rotating cam 205 is substantially restrained from moving along the axis of rotation 211.

In this example illustrative embodiment, the rotating cam 205 includes one or more ramped surfaces, which are also referred to as inclinations. The fixed cam 210 is restrained from rotating. Inclinations 208 included on the rotating cam 205 correspond to inclinations 213 included on the fixed cam 210. As the rotating cam 205 rotates, the inclinations included thereon engage with the inclinations included on the fixed cam 210. As this occurs, the sliding action of one inclination against the other causes displacement of the second cam 210 along the axis of rotation 211. Again, it is important to note that the rotating cam 205 is substantially restrained from moving along the axis of rotation 211.

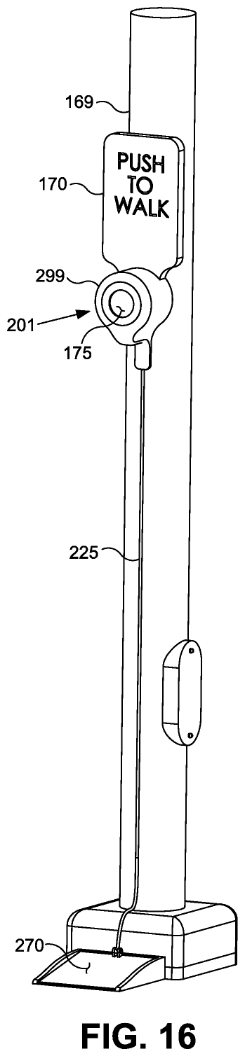

With reference to FIG. 16, one example embodiment of a push-to-walk button actuation mechanism includes the expanding cam assembly, a pedal 270 and a cable 225. It should be appreciated that the cable 225, according to various alternative example embodiments, conveys force applied to the pedal 272 to the rotating cam 205 included in the expanding cam assembly. It should be appreciated that, according to one illustrative use case, the expanding cam mechanism comprising the rotating cam 205 and the fixed cam 210 are installed onto a push-to-walk assembly 170, which includes a push-to-walk button 175. According to one alternative example embodiment, the fixed cam 210 provides an inner peripheral region 207 that is used to apply force to the push-to-walk button 175 when the fixed cam 210 is forced toward the push-to-walk button 175 when the rotating cam 205 is rotated.

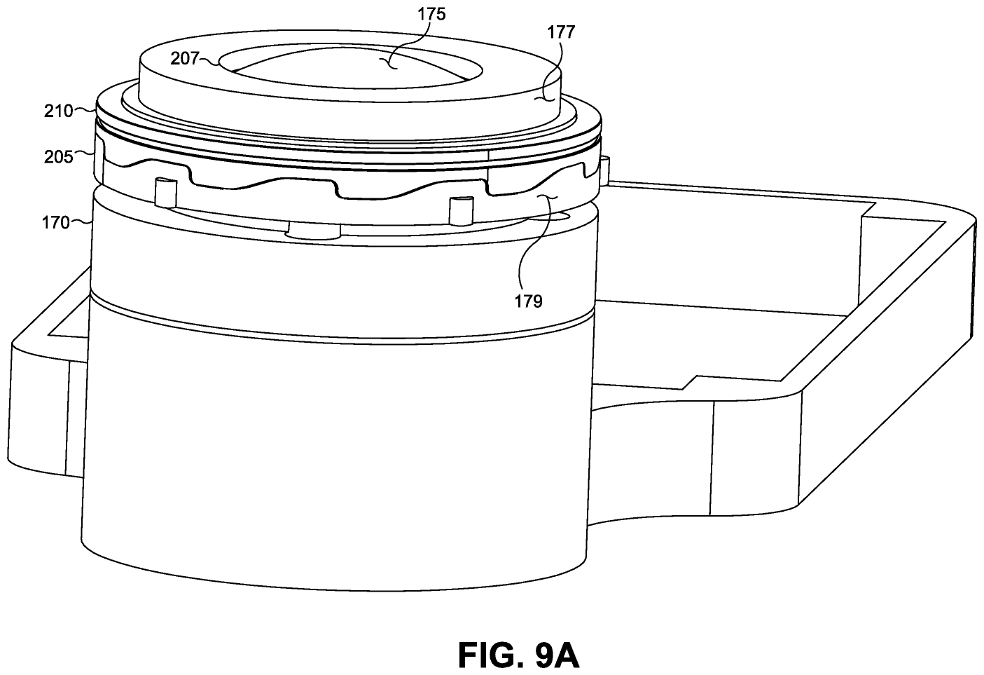

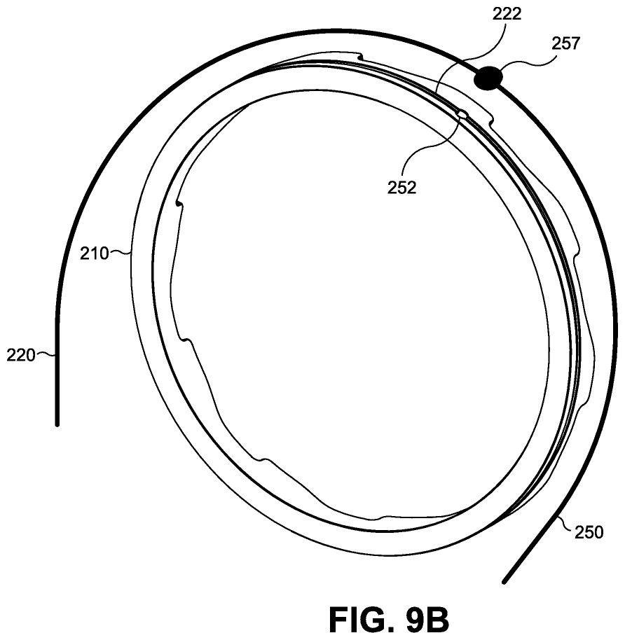

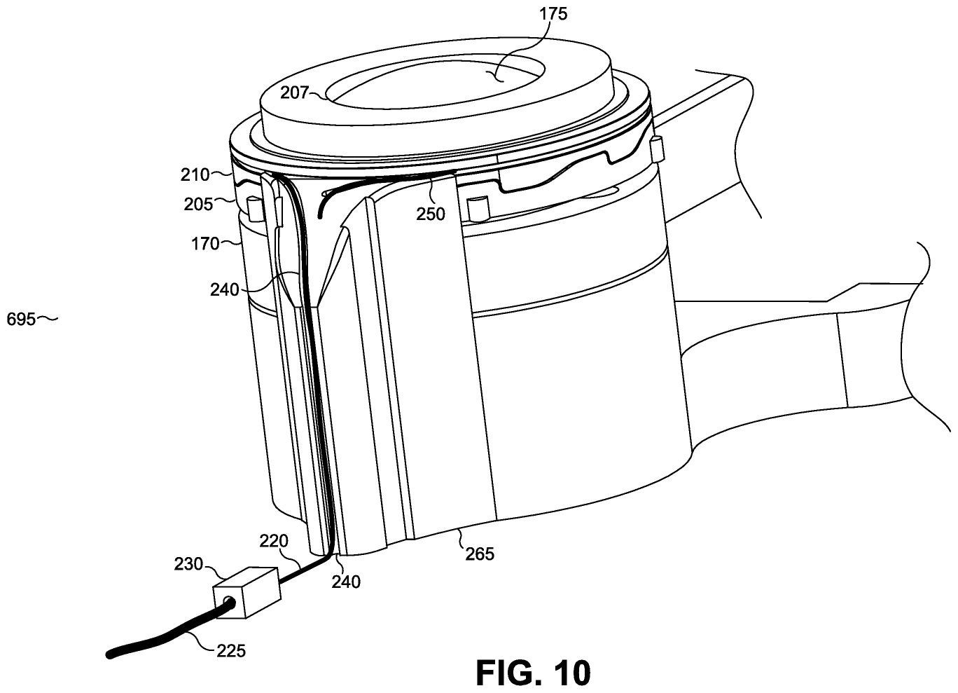

FIG. 9A is a pictorial diagram that illustrates the installation of an expanding cam mechanism relative to a push-to-walk button. In this diagram, it is evident that the fixed cam 205 is seated such that an inner periphery 207 comes in contact with the push-to-walk button 175. It should be appreciated that, according to this example embodiment, the fixed cam 205 includes a major diameter 179 and a minor diameter 177. The minor diameter of the fixed cam 205 is fashioned to fit within an inner diameter included in the rotating cam 210. In this example embodiment, the major diameter 179 of the fixed cam 205 is substantially equal to the outside diameter of the rotating cam 210.

When the expanding cam assembly 201 is installed on a push-to-walk assembly 170, the rotating cam 210 is disposed outward of the push-to-walk assembly 170. The major diameter 179 of the fixed cam 205 includes the inclinations which correspond to inclinations in the rotating cam 210.

FIG. 9B is a pictorial diagram that illustrates mechanical linkage of the rotating cam with a cord. According to this alternative example embodiment, the rotating cam 210 includes a slot 252, which is embossed into its outer peripheral wall. Also included in this alternative example embodiment is an attachment point 252. It should be appreciated that, according to this alternative example embodiment, the attachment point 252 comprises a wider section in the slot 222.

In this alternative example embodiment, the cord comprises a first section 220. The first section of the cord 220 includes a knurl 257, which is disposed at one end of the first section of the cord 220. In order to attach the first section of the cord 222 the rotating cam 210, the knurl 257 is placed within the attachment point 252. The first section of the cord 220 is then laid into the slot 222. According to this alternative example embodiment, the first section of the cord 220 serves as a linkage between the rotating cam 210 and the cable 225. It should be appreciated that the cord, according to various alternative example embodiments, comprises at least one or more of a string, a filament, a wire, and a ribbon. It should likewise be appreciated that the examples heretofore presented are not intended to limit the scope of the claims appended hereto.

According to yet another alternative example embodiment, the cord comprises a second section 250. In this alternative example embodiment, the cord's second section 250 is also connected to the knurl 257 facilitating attachment of the second section 250 to the rotating cam 210. As discussed below, the second section 250 of the cord is drawn upon by a tensioner, which causes the rotating cam 210 to counter-rotate when force pulling on the first section 220 of the cord is abated.

FIG. 10 is a pictorial diagram that illustrates use of a cord guide in one alternative example embodiment of an expanding cam assembly. According to this alternative example embodiment, the expanding cam assembly further comprises a cord guide 265. Various alternative example embodiments of the cord guide 265 include features which facilitates smooth operation of the expanding cam assembly.

In one alternative example embodiment, the cord guide 265 includes a cord way 240 that provides a path for the first section 220 of the cord. In this alternative example embodiment, the cord way 240 guides the first section of the cord 220 as it leaves tangentially from the slot 222 included in the rotating cam 210. It should be appreciated that, according to this alternative example embodiment, a cover included in yet another alternative example embodiment of the expanding cam assembly provides a barrier so as to retain the first section of the cord 220 in the cord way 240 as a force is applied to the end of the first section of the cord 220 by the cable 225.

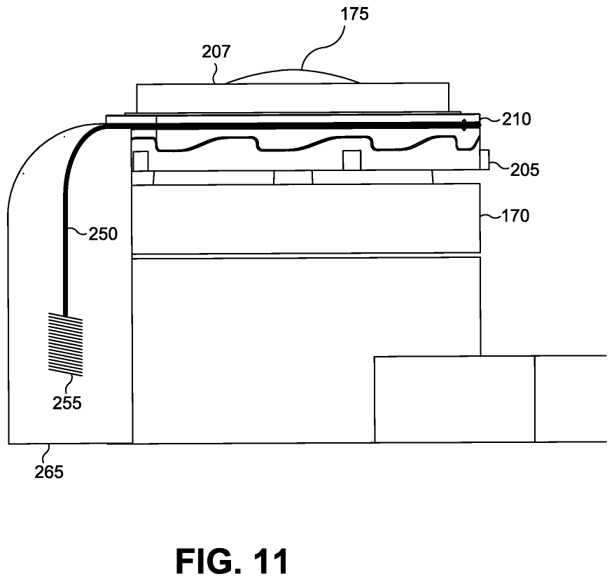

FIG. 11 is a pictorial diagram that illustrates the use of a tensioner in one alternative example embodiments. It should be appreciated that, when the force applied to the end of the first section 220 of the cord is abated, it is necessary to counter-rotate the rotating cam 210. This enables the fixed cam 205 to release pressure from the button 175. As illustrated in the figure, an inner peripheral portion 207 of the fixed cam 205 applies pressure (i.e. a force) downward on the push-to-walk button 175 when the rotating cam 210 is caused to rotate by application thereto of a tangential force received by way of the cable 225.

When this force is abated, a tensioner 255, included in one alternative example embodiment of the expanding cam assembly 201, draws upon the second section 250 of the cord. It should be noted that, according to this alternative example embodiment, the tensioner 255 is constantly engaged with the second section 250 of the cord and remains in greater tension and in opposition of the force applied to the first section 220 of the cord. In this alternative example embodiment, the tensioner 265 is mounted within the cord guide 265.

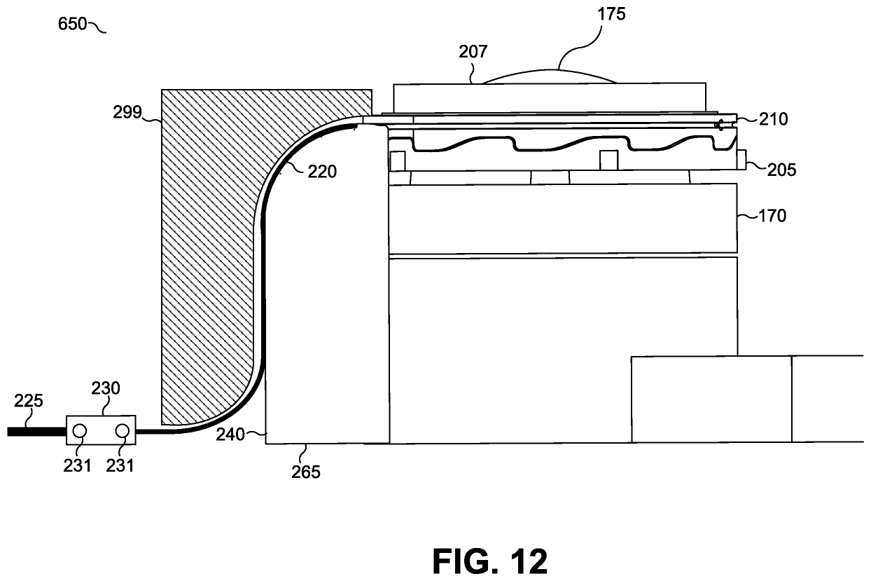

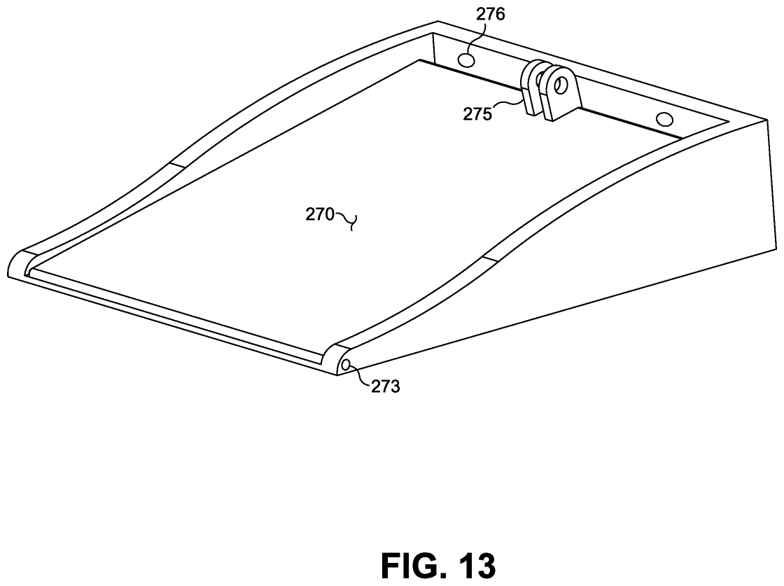

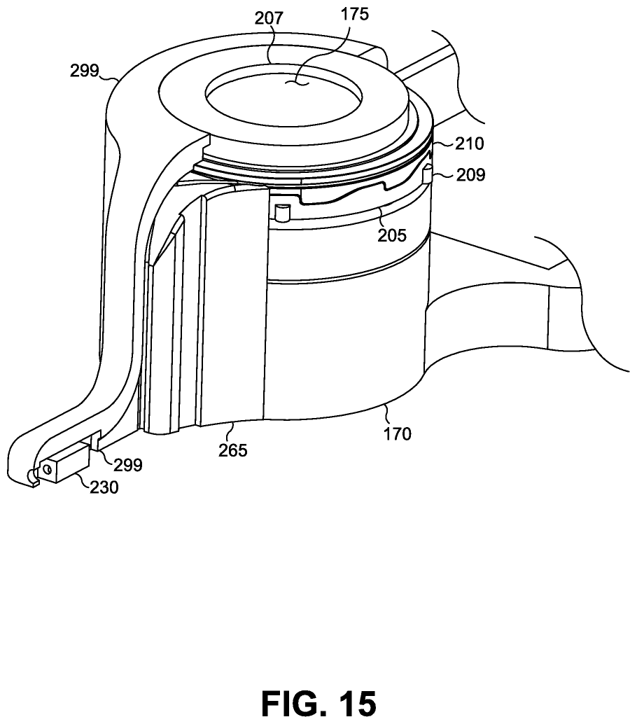

FIG. 12 is a diagram that illustrates the formation of a cord way in conjunction with a cover. As will be appreciated upon further reading of the specification, various alternative example embodiments of the expanding cam assembly 201 will be enclosed in a cover 299 (see FIG. 15). Even though the cord guide 265 includes a slot that forms a cord way 240, the cord way 240 may not be effective in certain configurations. Accordingly, when a force is applied to the cable 225, the court at 220 is pulled away from the push-to-walk button assembly 170. As such, in this alternative example embodiment, the cover 299 includes within its internal surface a corresponding slot so as to further guide the first portion 220 of the cord and to retain the first portion 220 of the cord and the cord way 240 included in the cord guide 265.

FIG. 12 further illustrates that, according to one alternative example embodiment, the cable 225 is attached to the first section of the cord at 220 by means of a coupler 230. According to various alternative example embodiments, the coupler 230, which is included in one alternative example embodiment of the expanding cam assembly 210, comprises a member that includes two holes on either end with each hole being serviced by a set screw 231. This example embodiment is only intended to illustrate the use of the coupler 230 and is not intended to limit the scope of the claims appended hereto.

FIG. 13 is a pictorial diagram that illustrates one example embodiment of a pedal assembly. According to this alternative example embodiment, pedal assembly includes a pedal 270. In this alternative example embodiment, the pedal 270 is hinged at a leading edge by an included pin 273 that allows the pedal to pivot about the included pin 273. It should be appreciated that, by inching the leading edge of the pedal 270, the pedal 270, according to various illustrative use cases, may be actuated by a human foot or by a wheel, for example a leading wheel of a wheelchair.

It should be appreciated that, according this alternative example embodiment, the pedal assembly includes a mounting means for attaching the pedal assembly to a pole, where in such pole is used to support a push-to-walk button assembly 170. In one alternative example embodiment, the attachment means comprises a mounting hole 276 which may be used to fasten, by means of a fastener, the pedal assembly to a pole.

It should likewise be appreciated that, according to this alternative example embodiment, the pedal 270 also includes the cable attachment means 275. The cable thousand means 275, according to one alternative example embodiment, comprises a bracket to which the cable 225 may be attached.

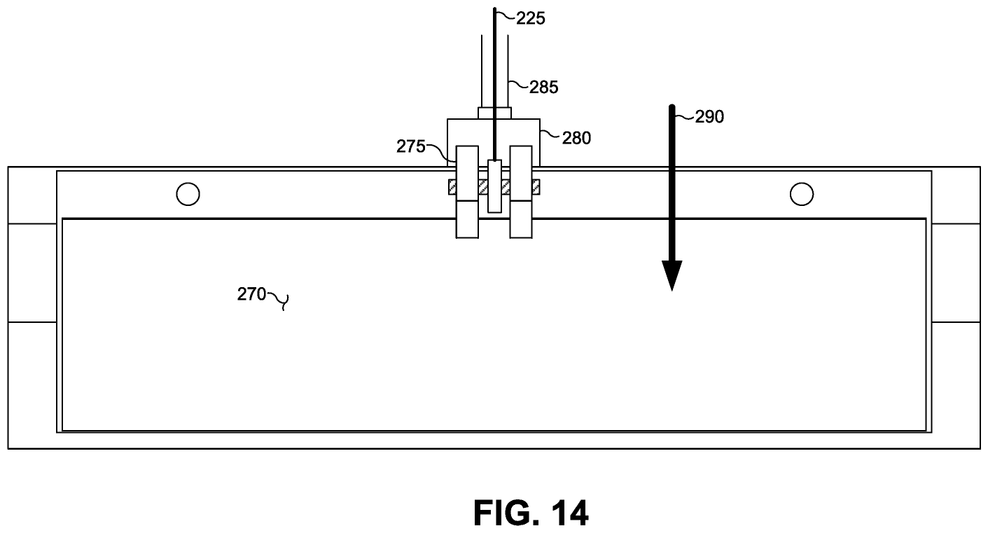

FIG. 14 is a pictorial diagram that illustrates attachment of a cable to a pedal. As illustrated in the figure, the pedal 270 includes a bracket 275. The bracket 275, according to various illustrative use cases, is used to attach the cable 225 to the pedal 270. When a downward force 290 is applied to the pedal 270, this causes the cable 225 to be drawn downward. This conveys a force that draws the cable 225 toward the pedal 270.

FIG. 14 further illustrates that, according to one alternative example embodiment, the cable 225 is enveloped in a shroud 285. In this alternative example embodiment, the shroud is prevented from being drawn toward the pedal 271 when a downward force 290 is imparted to the pedal 270. Accordingly, the shroud remains substantially fixed relative to motion exhibited by the cable 225. The fixed shroud 285 thereby serves as an effective raceway for the cable. It also be appreciated that, according to various alternative example embodiments, the shroud is similarly restrained proximate to the expanding cam assembly 201. It also should be appreciated that such a shrouded cable is commonly available as a break cable for a bicycle.

FIG. 15 is a pictorial diagram that illustrates application of a cover to an expanding cam assembly. As heretofore described, a cover 299, which is further included in one alternative example embodiment, envelopes the expanding cam assembly 201 and provides support for the cord guide 265. In one alternative example embodiment, the cover 299 also provides a guide path 229 for the coupler 230.

FIG. 16 is a pictorial diagram that illustrates one example embodiment of a push-to-walk button actuation mechanism as it may be installed on a push-to-walk button assembly. It should be appreciated that, according to various illustrative use cases, a push-to-walk button assembly 170 is installed on a pole 169. At least one alternative example embodiment of a push-to-walk button actuation mechanism is intended to be used as a retrofit to an existing push-to-walk button assembly 170 installation. Accordingly, the expanding cam assembly 201, including various accessories as described in alternative example embodiments, is installed over the push-to-walk button to 175.

The cable 225, according to one alternative example embodiment, is attached to the surface of the pole 169 and his routed downward toward the pedal assembly. The cable 225 is then attached to the pedal 270. In those embodiments where the cable 225 comprises a shrouded cable, a first end of the shroud is restrained at the pedal 270 so as to not allow that end to move toward the pedal 271 a force is applied to the pedal 270.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

what is claimed is:

1. A method for actuating a push-to-walk button:
receiving a force upon a pedal disposed proximate to a base of a pole that is supporting the push-to-walk button;
mechanically conveying the received force to a perimeter included in a first cam, wherein the force is applied to the first cam in a substantially tangential manner;
allowing the first cam to rotate according to the when the force is applied tangentially to the first cam;
imparting a force upon a second cam when the first cam is rotated, and wherein the force includes a component that is substantially aligned with an axis of rotation associated with the first cam; and
allowing the second cam to press upon the push-to-walk switch according to the force received from the first cam.

2. The method of claim 1 wherein receiving a force upon a pedal comprises at least one or more of receiving a force from a foot and/or receiving a force from a wheel.

3. The method of claim 1 wherein mechanically conveying a received force to a perimeter included in a first cam comprises:
attaching a flexible link to the pedal;
enveloping the flexible link in shroud;
fixing a first end of the shroud proximate to the pedal;
fixing a second end of the shroud proximate to the first cam;
conveying the force from the flexible link to the first cam; and
drawing the flexible link toward the pedal when a force is applied thereto.

4. The method of claim 1 wherein imparting a force upon a second cam when the first cam is rotated comprises causing a substantially normal force to be applied from an inclination included on a face of the first cam to a corresponding inclination included in the second cam.

5. The method of claim 1 wherein allowing the second cam to press upon the push-to-walk button comprises conveying to the push-to-walk button a force component received upon an inclination included on the second cam.

6. The method of claim 1 wherein allowing the second cam to press upon the push-to-walk switch comprises:
receiving a normal force component received from the first cam; and
transferring the normal force component to a peripheral region included in the push-to-walk button.

7. The method of claim 1 further comprising causing the first cam to counter rotate when the drawing force is abated.

8. A push-to-walk button actuation mechanism comprising:
expanding cam assembly that comprises:
fixed cam that includes at least one ramped surface and further includes at least one surface for actuating the push-to-walk button; and
rotating cam that includes at least one ramped surface that corresponds to the ramped surface included in the fixed cam and wherein the fixed cam and the rotating cam are forced away from each other as the rotating cam is rotated;
pedal including a mechanical attachment means, said attachment means capable of mounting the pedal to a vertical support associated with the push-to-walk button;
cable including a first end and a second end and wherein the first end of the cable is mechanically coupled to the pedal and the second end of the cable is mechanically coupled to rotating cam and wherein the rotating cam rotates when the cable is pulled toward the pedal when a force is applied to the pedal.

9. The push-to-walk button actuation mechanism of claim 8 wherein the pedal is structured to receive a force from a wheel.

10. The push-to-walk button actuation mechanism of claim 8 wherein the pedal is structure to receive a force from a foot.

11. The push-to-walk button actuation mechanism of claim 8 wherein the cable comprises a cable assembly that includes a flexible cable and a shroud that envelopes the flexible cable substantially from a point proximate to the pedal and substantially to a point proximate to the expanding cam assembly.

12. The push-to-walk button actuation mechanism of claim 8 wherein the expanding cam assembly further includes a cam-attachment-member that is attached at one end to a point on the periphery of the rotating cam and is attached at a second end to a cable coupler and wherein the second end of the cable is attached to the cable coupler.

13. The push-to-walk button actuation mechanism of claim 8 wherein the expanding cam assembly further includes a cam-attachment-member that includes a first end and a second end and is attached at a point between the first and second ends to a point on the periphery of the rotating cam and is attached at the second end to a cable coupler and is attached to a tensioner at the first end and wherein the tensioner causes the rotating cam to counter-rotate when there is no force drawing on the cable.
